(19) United States
(12) Patent Application Publication
(10) Pub. No.: US 2025/0389608 A1
(43) Pub. Date: Dec. 25, 2025

(54) CELL TESTING SYSTEMS AND CONTROL LOGIC FOR AUTOMATED IN-LINE LEAK DETECTION IN PRISMATIC BATTERY CELLS

(71) Applicant: GM GLOBAL TECHNOLOGY OPERATIONS LLC, Detroit, MI (US)

(72) Inventors: Hassan Ghassemi-Armaki, Northville, MI (US); Blair E. Carlson, Ann Arbor, MI (US); Ruiyao Wang, Walled Lake, MI (US); Cedrick D. Riley, Northville, MI (US)

(73) Assignee: GM GLOBAL TECHNOLOGY OPERATIONS LLC, Detroit, MI (US)

(21) Appl. No.: 18/751,408

(22) Filed: Jun. 24, 2024

(51) Int. Cl. G01M 3/04; G01J 5/00; G01J 5/08; G01J 5/48; H01M 10/42

(52) U.S. Cl. CPC G01M 3/04; G01J 5/0859; G01J 5/485; H01M 10/4228; G01J 2005/0077; H01M 2220/20

(57) ABSTRACT

Presented are smart testing systems for detecting leaks in electrochemical devices, methods for making/using such testing systems, and memory-stored instructions for automating operation of such systems. A method of detecting a leak in an electrochemical device includes positioning a temperature-controlled (TC) screen with an electrothermal device at a predefined distance from an infrared camera to define therebetween a test envelope. A testing system controller commands the electrothermal device to modify the TC screen's operating temperature to a predefined screen testing temperature. After positioning an electrochemical device in the test envelope, between the TC screen and infrared camera, the infrared camera captures infrared images of the electrochemical device within the test envelope, showing the device's housing located in front of the TC screen. The system controller then analyzes the captured infrared images of the electrochemical device to determine if a gas leak is present in the device housing.

### INTRODUCTION

The present disclosure relates generally to electrochemical devices. More specifically, aspects of this disclosure relate to systems and methods for detecting fluid leaks in cell cases during the manufacture of battery cells.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, corner modules, road wheels, etc.). Automobiles have historically been powered by a reciprocating-piston type internal combustion engine (ICE) assembly due to its ready availability and relatively inexpensive cost, light weight, and overall efficiency. Such engines include compression-ignited (CI) diesel engines, spark-ignited (SI) gasoline engines, two, four, and six-stroke architectures, and rotary engines, as some non-limiting examples. Hybrid-electric and full-electric vehicles (collectively “electric-drive vehicles”), on the other hand, utilize alternative power sources to propel the vehicle and, thus, minimize or eliminate reliance on a fossil-fuel based engine for tractive power.

A full-electric vehicle (FEV)—colloquially labeled an “electric car”—is a type of electric-drive vehicle configuration that altogether omits an internal combustion engine and attendant peripheral components from the powertrain system, relying instead on a rechargeable energy storage system (RESS) and a traction motor for vehicle propulsion. The engine assembly, fuel supply system, and exhaust system of an ICE-based vehicle are replaced with a single or multiple traction motors, rechargeable battery cells, and battery cooling and charging hardware in a battery-based FEV. Hybrid-electric vehicle (HEV) powertrains, in contrast, employ multiple sources of tractive power to propel the vehicle, most commonly operating an internal combustion engine assembly in conjunction with a battery-powered or fuel-cell-powered traction motor. Since hybrid-type, electric-drive vehicles are able to derive their power from sources other than the engine, HEV engines may be turned off, in whole or in part, while the vehicle is propelled by the electric motor(s).

Many commercially available hybrid electric and full electric vehicles employ a rechargeable traction battery pack to store and supply the requisite power for operating the powertrain's traction motor unit(s). In order to generate tractive power with sufficient vehicle range and speed, a traction battery pack is significantly larger, more powerful, and higher in capacity (Amp-hr) than a standard 12-volt starting, lighting, and ignition (SLI) battery. Contemporary traction battery packs, for example, group stacks of battery cells (e.g., 12-75 cells/group) into individual battery modules (e.g., 10-40 modules/pack) that are mounted onto the vehicle chassis by a battery pack housing or support tray. Stacked electrochemical battery cells may be connected in series or parallel through use of an electrical interconnect board (ICB) or front-end DC bus bar assembly. A dedicated Electronic Battery Control Module (EBCM), through collaborative operation with a Powertrain Control Module (PCM) and Traction Power Inverter Module (TPIM), regulates the opening and closing of pack contactors to govern operation of the battery pack.

There are four primary types of batteries that are used in electric-drive vehicles: lithium-class batteries, nickel-metal hydride batteries, ultracapacitor batteries, and lead-acid batteries. As per lithium-class designs, lithium-metal and lithium-ion (Li-ion) batteries make up the bulk of commercial lithium battery (LiB) configurations, with Li-ion batteries being employed in automotive applications due to their enhanced stability, energy density, and rechargeable capabilities. A standard lithium-ion cell is generally composed of at least two conductive electrodes, an electrolyte material, and a permeable separator, all of which are enclosed inside an electrically insulated packaging. One electrode serves as a positive (“cathode”) electrode and the other electrode serves as a negative (“anode”) electrode during cell discharge. The separator—oftentimes a microporous polymeric membrane—is disposed between a mated pair of working electrodes to prevent electrical short circuits while also allowing the transport of ionic charge carriers. Rechargeable Li-ion batteries operate by reversibly passing lithium ions back-and-forth between the negative and positive working electrodes. During the manufacture of many Li-ion battery cells, especially lithium-metal, prismatic-type cells, a metered volume of compressed gas, such as carbon dioxide (CO₂), is injected into the cell's rigid battery case in order to pressurize the cell. To ensure continuous and uninterrupted operation of the battery system, each cell is tested during the manufacturing process to confirm that there are no leaks in the cell case.

### SUMMARY

Presented below are smart testing systems with control logic for detecting fluid leaks in electrochemical devices, methods for manufacturing and methods for operating such testing systems, and memory-stored instructions for automating operation of such systems. By way of example, and not limitation, an automated system and method uses infrared Optical Gas Imaging (OGI) sensors to enable in-line detection of gas leaks in prismatic cell cases. Prismatic cells may be pressurized with CO₂ or other compressed gas; each cell is scanned in the Middle Wavelength Infrared (MWIR) range against a heated backdrop to determine whether or not gas is leaking out from the cell case. The system may actively monitor and control both the infrared wave output of the heated backdrop and any thermal variations in the test envelope. An optional mirror assembly and angled heated plate may be used to govern IR wave flow in order to visualize areas that lie behind the cell case's fill port. The leak detection algorithm used to analyze the infrared images of the prismatic cell may offer a high tolerance to variations in cell position, gas pressure, background temperature, and atmospheric turbulence.

A representative smart testing system and method may employ six automated processes to detect leaks in prismatic battery cells: (1) a temperature-controlled screen is positioned at a fixed distance from an OGI camera while a system programmable logic controller (PLC) (a) uses a temperature sensor attached to the front bottom edge of the screen to monitor and control ambient temperature, and (b) uses the OGI camera to ensure a minimal temperature gradient across the test envelope before cell analysis is initiated; (2) upon arrival of a battery cell within the test envelope, (a) an evac/fill tube is lowered into contact with and sealed to the cell, and (b) an optional background-plus-mirror assembly is simultaneously positioned adjacent a fill port of the cell case; (3) the PLC initiates and controls an evacuation cycle using a vacuum pump, a pressure sensor, and an on/off relay; (4) the PLC initiates a fill routine and (a) switches open a flow-control valve to allow CO₂ into the cell till a desired pressure is reached, and (b) once pressurized, the flow-control valve is closed; (5) the PLC activates the OGI camera and simultaneously launches a leak detection algorithm to detect the existence and position of any leaks, including leaks that may lie behind the fill nozzle, e.g., using the mirror; and (6) the evac/fill tube and the background-plus-mirror assembly are retracted before the cell moves on to the next station.

Aspects of this disclosure are directed to test system control protocols, system control logic, and memory-stored instructions that provision automated, in-line leak detection for electrochemical devices. In an example, a method is presented for detecting a leak in an electrochemical device, such as CO₂ gas leaks in the cell case of a prismatic battery cell. This representative method includes, in any order and in any combination with any of the above and below disclosed options and features: positioning, e.g., via a servomotor-controlled guide cylinder, a temperature-controlled (TC) screen with an electrothermal device at a predefined distance from an infrared camera to define therebetween a test envelope; commanding, e.g., via a resident or remote controller, logic device, module, or network of controllers/modules/devices (collectively “controller”), the electrothermal device to increase/decrease (modify) the TC screen's operating temperature to a predefined screen testing temperature; positioning, e.g., via a conveyor system, an electrochemical device in the test envelope, interposed between the TC screen and infrared camera; capturing, e.g., using the infrared camera and a process PC memory, one or more infrared images of the electrochemical device within the test envelope, showing the device housing located in front of the heat-generating TC screen; and analyzing, e.g., via the system controller using an image analysis module, the captured infrared image(s) of the electrochemical device to determine if a gas leak is present in the device housing.

Aspects of this disclosure are also directed to computer-readable media (CRM) containing controller-executable instructions that provision automated, in-line leak detection for electrochemical devices. In an example, a non-transient CRM stores instructions that are executable by one or more processors of a system controller (e.g., PLC, Process PC, and digital temperature controller) of a leak testing system for detecting a leak in an electrochemical device. The electrochemical device (e.g., a lithium-class prismatic battery cell) includes a device housing (e.g., insulated-metal cell case) with a fill port (e.g., cell header fill nozzle). The CRM-stored instructions, when executed by the processor(s), cause the system controller to perform operations, including: commanding a screen mover to position a temperature-controlled screen with an electrothermal device at a predefined distance from an infrared camera to define therebetween a test envelope; commanding the electrothermal device to increase a screen operating temperature of the TC screen to a predefined screen testing temperature; confirming the electrochemical device is positioned in the test envelope between the TC screen and the infrared camera; capturing, using the infrared camera, an infrared image of the electrochemical device within the test envelope showing the device housing located in front of the TC screen; and analyzing the captured infrared image of the electrochemical device to determine if a gas leak is present in the device housing.

Additional aspects of this disclosure are directed to automated, in-line leak testing systems for detecting gas leaks in electrochemical devices, such as prismatic battery cells for vehicle battery packs. As used herein, the terms “vehicle” and “motor vehicle” may be used interchangeably and synonymously to include any relevant vehicle platform, such as passenger vehicles, commercial vehicles, industrial vehicles, off-road and all-terrain vehicles (ATV), motorcycles, farm equipment, watercraft, aircraft, spacecraft, etc. For non-automotive applications, disclosed concepts may be implemented for any logically relevant use, including portable power stations, photovoltaic systems, pumping equipment, wind turbine farms, server systems, etc. In an example, a leak testing system includes a standalone or line-integrated test fixture and an infrared camera securely mounted to the test fixture. A TC screen, which includes an electrothermal device attached to a thermally conductive plate, is movably mounted via a controller-automated screen mover to the test fixture proximate the infrared camera. A system controller is wired or wirelessly connected to the electrothermal device, the screen mover, and the infrared camera.

Continuing with the discussion of the foregoing example, the system controller is programmed to command the screen mover to position the TC screen at a predefined distance from the infrared camera to define therebetween a test envelope. Prior to, contemporaneous with, or after positioning the TC screen, the system controller commands the electrothermal device to increase the TC screen's operating temperature to a predefined screen testing temperature. The system controller also confirms the electrochemical device is positioned in the test envelope, interposed between the TC screen and infrared camera; once confirmed, the controller commands the infrared camera to capture one or more infrared images of the electrochemical device within the test envelope, showing the device housing and fill port located in front of the TC screen. The system controller then analyzes the captured infrared image(s) to identify a gas leak, if any, in the device housing of the electrochemical device.

For any of the disclosed systems, methods, and CRM, the leak testing system's controller may communicate with a temperature sensor attached to the TC screen to receive sensor signals indicative of a real-time operating temperature of the TC screen. In this instance, the system controller may command the electrothermal device to actively modulate the TC screen's operating temperature based on the sensed real-time operating temperature of the TC screen. In at least some system configurations, the temperature sensor may be mounted to a bottom edge of a front camera-facing surface of the TC screen. As another option, the system controller may use the infrared camera to monitor a temperature gradient across the test envelope. In this instance, the system controller may command the electrothermal device to actively modulate the TC screen's operating temperature to thereby maintain the temperature gradient at a gradient value that is less than or equal to a predefined maximum allowable temperature gradient.

For any of the disclosed systems, methods, and CRM, the system controller may command a hydraulic, pneumatic, or electromechanical linear press to move an evac/fill tube into contact with the fill port of the device housing after the electrochemical device is positioned in the test envelope. In this instance, the system controller may then command the linear press to seal the evac/fill tube to the fill port (e.g., by generating a predefined contact pressure between the tube and port). A controller-automated fluid pump may be fluidly coupled to the evac/full tube via an electronic flow control valve. After the evac/fill tube is sealed to the fill port, the system controller may command the fluid pump to evacuate gas from the device housing through the fill port to produce a predefined vacuum pressure within the device housing. After the fluid pump evacuates gas from the device housing, the system controller may command the flow control valve to open and thereby transmit pressurized gas into the device housing through the evac/fill tube and the fill port. The flow control valve may be a three-way, multiport electronic pressure center valve that fluidly couples the fluid pump and a pressurized gas container to the evac/fill tube.

For any of the disclosed systems, methods, and CRM, a mirror assembly may be positioned between the device housing's fill port and a select portion of the TC screen. In this instance, the mirror assembly may be securely mounted to and, thus, moves in unison with the TC screen. As another option, analyzing the captured infrared image(s) of the electrochemical device may include first evaluating imaged MWIR waves that are generated by the electrothermal device and pass between the TC screen and the device housing. The system controller then locates any aberrations within the imaged MWIR waves; each aberration is caused by compressed gas leaking from the device housing. For at least some system configurations, the TC screen includes a U-shaped plate assembly with a metallic center plate and a pair of metallic flaps each projecting orthogonally from a respective opposing edge of the metallic center plate. In this instance, the electrothermal device may be a silicone rubber heating pad that is bonded, e.g., via a thermally conductive, pressure-sensitive adhesive (PSA), to the center plate and metallic flaps such that MWIR waves generated by the electrothermal device pass from the silicone rubber heating pad, through the metallic plate/flaps, and across the device housing. An air-flow restricting canopy (e.g., open-bottomed plexiglass vessel) may be positioned around the TC screen and the electrochemical device to regulate flow around the device during testing.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle that is propelled by an electrified powertrain and powered by a traction battery pack containing rechargeable battery cells with which aspects of this disclosure may be practiced.

FIG. 2 is a schematic illustration of a representative electrochemical device with which aspects of this disclosure may be practiced.

FIG. 3 is a schematic diagram of a representative battery cell testing system and method for automating in-line gas leak detection of prismatic battery cells in accord with aspects of the present disclosure.

FIGS. 4-8 are flowcharts illustrating a representative testing system control protocol for in-line automation of leak detection in electrochemical devices, which may correspond to memory-stored instructions that are executable by a resident or remote microcontroller, programmable logic circuit, control module, or other integrated circuit (IC) device or network of circuits/modules/microcontrollers/IC devices (collectively “system controller”) in accordance with aspects of the disclosed concepts.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

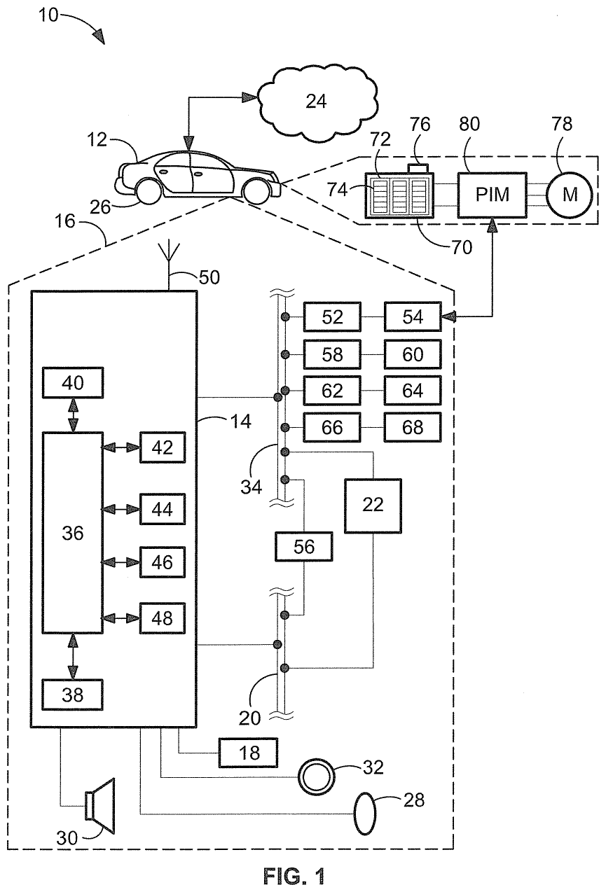

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which aspects of this disclosure may be practiced. In the same vein, incorporation of the present concepts into the illustrated battery testing system for detecting leaks in lithium-class prismatic battery cells should be appreciated as a non-limiting implementation of disclosed features. As such, it will be understood that aspects and features of this disclosure may be incorporated into other test system architectures, may be utilized for testing any logically relevant type of electrochemical device, and may be utilized for both automotive and non-automotive applications alike. Moreover, only select components of the motor vehicle, testing system, and battery cell are shown and described in detail herein. Nevertheless, the vehicles, systems and cells discussed below may include numerous additional and alternative features, and other available peripheral hardware, for carrying out the various methods and functions of this disclosure.

The representative vehicle 10 of FIG. 1 is originally equipped with a vehicle telecommunications and information (“telematics”) unit 14 that wirelessly communicates, e.g., via cellular network, satellite service, wireless-enabled modem, etc., with a remotely located or “off-board” cloud computing host service 24 (e.g., ONSTAR®). Some of the other vehicle hardware components 16 shown generally in FIG. 1 include, as non-limiting examples, an electronic video display device 18, a microphone 28, audio speaker(s) 30, and assorted user input controls 32 (e.g., buttons, knobs, switches, joysticks, touchscreens, etc.). These hardware components 16 function, in part, as a human/machine interface (HMI) that enables a user to communicate with the telematics unit 14 and other components both resident to and remote from the vehicle 10. Microphone 28, for instance, provides occupants with a means to input verbal commands; the vehicle 10 may be equipped with embedded audio filtering, editing, and analysis modules for processing the commands. Conversely, the speaker 30 provides audible output to a vehicle occupant and may be either a stand-alone speaker or may be part of an audio system 22. The audio system 22 is operatively connected to a network connection interface 34 and an audio bus 20 to receive analog information, rendering it as sound, via one or more speaker components.

Communicatively coupled to the telematics unit 14 is a network connection interface 34, suitable examples of which include fiberoptic Ethernet switches, parallel/serial communications buses, local area network (LAN) interfaces, controller area network (CAN) interfaces, and the like. The network connection interface 34 enables the vehicle hardware 16 to send and receive signals with one another and with various systems both onboard and off-board the vehicle body 12. This allows the vehicle 10 to perform assorted vehicle functions, such as modulating powertrain output, activating friction and regenerative brake systems, controlling vehicle steering, and other automated functions. For instance, telematics unit 14 may exchange signals with a Powertrain Control Module (PCM) 52, an Advanced Driver Assistance System (ADAS) module 54, an Electronic Battery Control Module (EBCM) 56, a Steering Control Module (SCM) 58, a Brake System Control Module (BSCM) 60, and assorted other vehicle ECUs, such as a transmission control module (TCM), engine control module (ECM), Sensor System Interface Module (SSIM), etc.

With continuing reference to FIG. 1, telematics unit 14 is an onboard computing device that provides a mixture of services, both individually and through its communication with other networked devices. This telematics unit 14 may be generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to a real-time clock (RTC) 42 and one or more electronic memory devices 38, each of which may take on the form of a CD-ROM, magnetic disk, IC device, a solid-state drive (SSD) memory, a hard-disk drive (HDD) memory, flash memory, semiconductor memory (e.g., various types of RAM or ROM), etc.

Long-range communication (LRC) capabilities with remote, off-board devices may be provided via one or more or all of a cellular chipset/component, a navigation and location chipset/component (e.g., global positioning system (GPS) transceiver), or a wireless modem, all of which are collectively represented at 44. Close-range wireless connectivity may be provided via a short-range communication (SRC) device 46 (e.g., a BLUETOOTH® unit or near field communications (NFC) transceiver), a dedicated short-range communications (DSRC) component 48, and/or a dual antenna 50. The communications devices described above may provision data exchanges as part of a periodic broadcast in a vehicle-to-vehicle (V2V) communication system or a vehicle-to-everything (V2X) communication system.

CPU 36 receives sensor data from one or more sensing devices that use, for example, photo detection, radar, laser, ultrasonic, optical, infrared, or other suitable technology, for executing a controller-automated (AV/ADAS) driving operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of in-vehicle sensors may be adapted, singly or collectively, to a given vehicle platform for achieving a desired level of automated vehicle operation.

To propel the motor vehicle 10, an electrified powertrain is operable to generate and deliver tractive torque to one or more of the vehicle's drive wheels 26. The powertrain is represented in FIG. 1 by a rechargeable, chassis-mounted traction battery pack 70 that is operatively connected to an electric traction motor (M) 78. The traction battery pack 70 is generally composed of one or more battery modules 72 each containing a cluster of battery cells 74, such as lithium-class or organosilicon-class cells of the pouch, prismatic, or cylindrical type. One or more electric machines, such as traction motor/generator (M) units 78, draw electrical power from and, optionally, deliver electrical power to the battery pack 70. A power inverter module (PIM) 80 electrically connects the battery pack 70 to the motor(s) 78 and modulates the transfer of electrical current therebetween. The battery pack 70 may include an integrated electronics package, such as a wireless-enabled cell monitoring unit (CMU) 76, that enables module management, cell sensing, and module communications functionality.

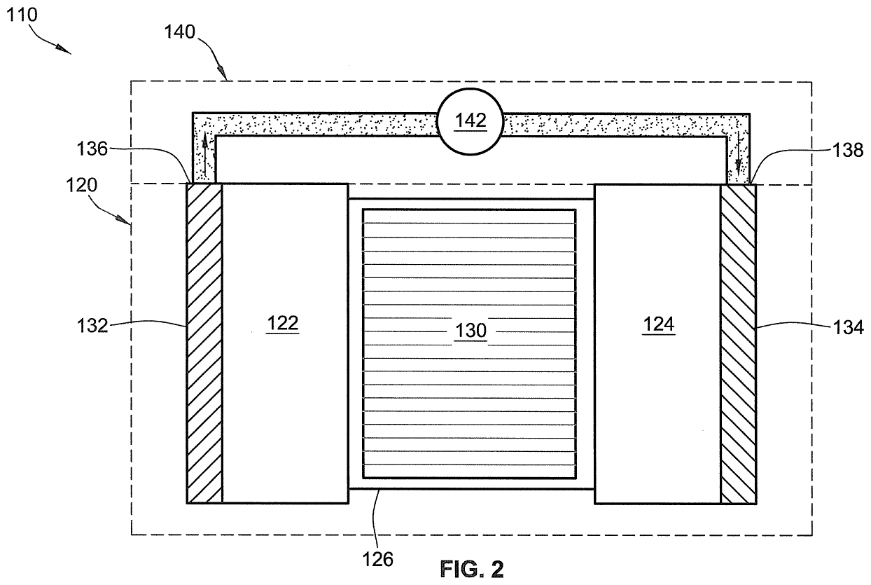

Presented in FIG. 2 is an exemplary electrochemical device in the form of a rechargeable lithium-class battery 110 that powers a desired electrical load, such as motor 78 of FIG. 1. Battery 110 includes a series of electrically conductive electrodes, namely a first (negative or anode) working electrode 122 and a second (positive or cathode) working electrode 124 that are stacked and packaged inside a protective outer housing 120 (also referred to herein as “cell case” or “housing”). Reference to either working electrode 122, 124 as an “anode” or “cathode” or, for that matter, as “positive” or “negative” does not limit the electrodes 122, 124 to a particular polarity as the system polarity may change depending on whether the battery 110 is being operated in a charge mode or a discharge mode. The device housing 120 (also referred to herein as “cell case”) may take on a cylindrical construction, a pouch construction, or a prismatic construction that is formed of aluminum, nickel-plated steel, ABS, PVC, or other suitable material. A metallic case may be coated with a polymeric finish to insulate the metal from internal cell elements and from adjacent cells. Although FIG. 2 shows a single galvanic monocell unit enclosed within the cell case 120, it should be appreciated that the housing 120 may store a stack or roll of monocell units (e.g., five to 500 cells or more).

Anode electrode 122 may be fabricated with an active anode electrode material that is capable of incorporating lithium ions during a battery charging operation and releasing lithium ions during a battery discharging operation. For at least some designs, the anode electrode 122 is manufactured, in whole or in part, from a lithium metal, such as lithium-aluminum (LiAl) alloy materials with an Li/Al atomic ratio (as indicated by an atomic percent (at. %) of one type of atom relative to a total number of atoms) in a range from 0 at. %≤Li/Al<70 at. %, and/or aluminum alloys with Al atomic ratio>50 at. % (e.g., lithium metal is smelt). Additional non-limiting examples of suitable active anode materials include carbonaceous materials (e.g., graphite, hard or soft carbon etc.), silicon, silicon-carbon blended materials (silicon-graphite composite), Li₄Ti₅O₁₂, transition-metals (alloy types, e.g., Sn), metal oxide/sulfides (e.g., SnO₂, FeS and the like), etc.

Cathode electrode 124 may be fabricated with an active cathode electrode material that is capable of supplying lithium ions during a battery charging operation and incorporating lithium ions during a battery discharging operation. The cathode 124 material may include, for instance, lithium transition metal oxide, phosphate (including olivines), or silicate, such as LiMO₂ (M=Co, Ni, Mn, or combinations thereof); LiM₂O₄ (M=Mn, Ti, or combinations thereof), LiMPO₄ (M=Fe, Mn, Co, or combinations thereof), and LiMxM′2-xO4 (M, M′=Mn or Ni). Additional non-limiting examples of suitable active cathode materials include lithium nickel cobalt manganese oxide (NCM), lithium nickel cobalt aluminum oxide (NCA), lithium nickel cobalt manganese aluminum oxide (NCMA), and other lithium transition-metal oxides.

Disposed inside the cell case 120 of FIG. 2 and sandwiched between each mated pair of working electrodes 122, 124 is an electrically isolating porous separator 126. The separator 126 may be in the nature of an electrically non-conductive, ion-transporting microporous or nanoporous polymeric separator sheet. Separator 126 may be a sheet-like structure that is composed of a porous polyolefin membrane, e.g., with a porosity of about 35% to about 65%. Electrically non-conductive ceramic particles (e.g., silica) may be coated onto the porous membrane surfaces of the separators 126. The porous separator 126 may incorporate a non-aqueous fluid electrolyte composition, a solid electrolyte composition, and/or a quasi-solid electrolyte composition, collectively designated 130, which may also be present in the negative electrode 122 and the positive electrode 124. The porous separator 126 may operate as both an electrical insulator and a mechanical support structure by being sandwiched between the two electrodes 122, 124 to prevent the electrodes from physically contacting each other and, thus, the occurrence of a short circuit. In addition to providing a physical barrier between the electrodes 122, 124, the separator 126 may provide a minimal resistance path for internal passage of lithium ions (and related anions) during cycling of the lithium ions to facilitate functioning of the battery 110.

A negative electrode current collector 132 of the electrochemical battery cell 110 may be positioned on or near the negative electrode 122, and a positive electrode current collector 134 may be positioned on or near the positive electrode 124. The negative electrode current collector 132 and positive electrode current collector 134 respectively collect and move free electrons to and from an external circuit 140. An interruptible external circuit 140 with a load 142 connects to the negative electrode 122, through its respective current collector 132 and negative electrode tab 136, and to the positive electrode 124, through its respective current collector 134 and positive electrode tab 138.

Operating as a rechargeable energy storage device, the battery 110 generates electric current that is transmitted to one or more electric loads 142 operatively connected to the external circuit 140. While the load 142 may be any number of devices, a few non-limiting examples of power-consuming devices include electric traction motors for hybrid-electric and full-electric vehicles, photovoltaic cell arrays, standalone power stations and portable power packs, server systems, wind turbine farms, etc. The battery cell 110 may include a variety of other components including fluid-sealing gaskets, terminal caps, cell headers, tabs, battery terminals, cooling hardware, charging hardware, and other commercially available components that may be situated on or in the battery 110. Moreover, the size and shape and operating characteristics of the battery 110 may vary depending on the particular application for which it is designed.

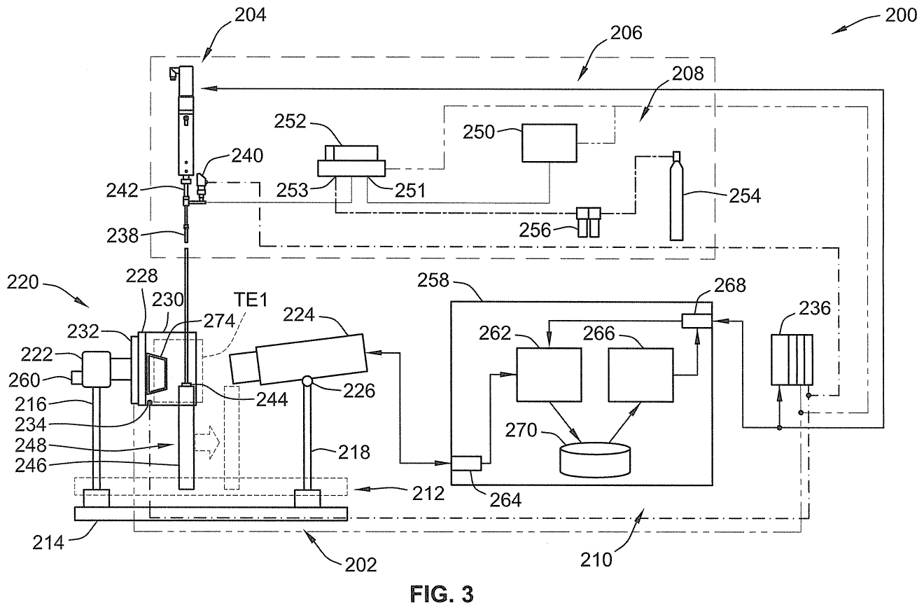

FIG. 3 schematically illustrates a non-limiting example of a battery cell testing system 200 for automating in-line gas leak detection of prismatic battery cells. In accord with the illustrated example, the testing system 200 is composed of six interoperable subsystems: (1) a standalone test fixture 202 subsystem; (2) a high-precision linear press 204 subsystem; (3) a pump-assisted evacuation (evac) subsystem 206; (4) a compressed-gas feed subsystem 208; (5) a system controller 210 network; and (6) a cell conveyor subsystem 212. While not per se limited, the test fixture 202 of FIG. 3 may include a rigid support platform 214 with a pair of (first and second) support stanchions 216 and 218, each of which is securely mounted on and projects vertically upwards from the support platform 214. A temperature-controlled (TC) screen 220 assembly is movably mounted onto a top end of the left (first) support stanchion 216 via a servomotor-controlled guide cylinder 222. Juxtaposed with the TC screen 220 is an infrared Optical Gas Imaging (OGI) camera 224 (e.g., mid-range optical FLIR sensor capturing 10-200 frames per second (fps)) that is pivotably mounted onto a top end of the right (second) support stanchion 218 via a rotating mounting bracket 226. It is envisioned that the battery cell testing system 200 may take on different architectures, may comprise greater or fewer than six interoperable subsystems, and may utilize similar or different subsystem types from that which are shown in the Figures.

To enable active thermal control of the testing process, the TC screen 220 of FIG. 3 includes a U-shaped plate assembly that is generally typified by a thermally conductive (metallic) center plate 228 with a pair of thermally conductive (first and second metallic) flaps 230, each of which projects orthogonally from a respective opposing (first or second) edge of the center plate 228. The center plate 228 and adjoining flaps 230 may be fabricated from individual anodized aluminum plates that are joined together, e.g., via welding or brackets; alternatively, the center plate 228 and adjoining flaps 230 may be formed as a one-piece structure from a single anodized aluminum plate. An electrothermal device 232, which may be in the nature of a silicone rubber heating pad, is bonded, e.g., via a thermally conductive, pressure-sensitive adhesive (PSA) or epoxy-based thermal interface material (TIM) adhesive, to the rear faces of the center plate 228 and adjoining flaps 230. A temperature sensor, such as laser-based digital infrared sensor head 234, is operatively attached to the TC screen 220 (e.g., mounted to a bottom edge of a front camera-facing surface of the center plate 228). The temperature sensor 234 senses a real-time operating temperature of the TC screen 220 and outputs temperature sensor signals indicative thereof to a system programmable logic controller (PLC) 236. With this arrangement, the PLC 236 portion of the system controller 210 network may govern the heat output of the electrothermal device 232 to actively modulate the TC screen's operating temperature based on the sensed real-time operating temperature of the TC screen 220.

With continuing reference to FIG. 3, the high-precision linear press 204 may be mounted onto the test fixture 202 above the deployable TC screen 220. The linear press 204 may be a one (1) kilo-Newton (kN) hydraulic, pneumatic, or electromechanical press with force and/or displacement feedback. An evac/fill tube 238 and a vacuum pressure sensor 240 are mounted onto a distal (bottom) end of a linearly translatable ram 242 that is operable to move the evac/full tube 238 into contact with a fill port 244 in the header of a device housing 246 of an electrochemical device 248. Although differing in appearance, the electrochemical device 248 of FIG. 3 may take on any of the features and options described above with respect to the rechargeable lithium-class battery 110 of FIG. 2. With this arrangement, the PLC 236 portion of the system controller 210 network may activate the linear press 204 to align, abut and seal the evac/fill tube 238 to the fill port 244 (e.g., adding at least five (5) pound (lbs.) pressure to the port 244 via the tube 238 to create a fluid-tight seal).

To enable controlled pressurization of the electrochemical device 248, the pump-assisted evac subsystem 206 employs a controller-automated fluid pump 250 that is fluidly coupled to the evac/full tube 238 via an electronic flow control valve 252. According to the illustrated example, the flow control valve 252 is a three-way, five-port electronic pressure center valve. Once the evac/fill tube 238 is fluidly sealed to the device housing's fill port 244, the PLC 236 portion of the system controller 210 network may command the flow control valve 252 to open an exhaust port 251 connecting the evac/full tube 238 to the fluid pump 250, which may be a regulated electronic vacuum pump activated by an ON/OFF relay switch. PLC 236 may contemporaneously activate the fluid pump 250 to selectively evacuate gas from the device housing 246 through the fill port 244 to produce a predefined vacuum pressure within the housing 246. When the device housing 246 reaches the desired vacuum pressure level, the PLC 236 may command the flow control valve 252 to close the exhaust port 251 and thereby fluidly decouple the fluid pump 250 from the evac/full tube 238.

Upon completion of the evacuation process, the compressed-gas feed subsystem 208 employs a pressurized gas container 254 and a gas preparation device 256 to transmit pressurized gas into the device housing 246 through the flow control valve 252 and evac/full tube 238. As shown, the pressurized gas container 254 is an aluminum alloy CO₂ tank that is pressured, e.g., to at least 1 pound per square inch (psi), and is fluidly coupled to an intake port 253 of the flow control valve 252 via the gas preparation (CO2-prep) device 256, with the container 254 located fluidly upstream from device 256. After the fluid pump 250 evacuates gas from the device housing 246, the PLC 236 portion of the system controller 210 network may command the flow control valve 252 to open the intake port 253 to thereby fluidly connect the pressurized gas container 254 and the CO2-prep device 256 to the fill port 244 via the evac/full tube 238. Once fluidly connected, the container 254 transmits pressurized CO₂ into the device housing 246 through the evac/fill tube 238 and fill port 244. When the device housing 246 is filled with a desired volume of compressed gas, the PLC 236 may command the flow control valve 252 to close the intake port 253 and thereby fluidly decouple the container 254 from the tube 238.

Automated control of the battery cell testing system 200 is provided by the system controller 210 network, which may be composed of the PLC 236, a process server-class (PC) computer 258, and a digital temperature controller 260. An image capture module 262 resident to the PC computer 258 is communicatively connected to the OGI camera 224 by a first network-interface controller 264 and governs operation of the camera 224. In a similar regard, the image capture module 262 and an image analysis module 266 resident to the PC computer 258 are communicatively connected to the PLC 236 by a second network-interface controller 268. The image analysis module 266 analyzes captured infrared images of the electrochemical device 248 to determine if a gas leak is present in the device housing 246. Both the image capture module 262 and the image analysis module 266 are communicatively connected to a server system database 270 resident to the PC computer 258. The cell conveyor system 212 may be a modular, motorized belt-type or roller-type conveyor system that automates transfer of each electrochemical device 248 into and out of a test envelope defined between the TC screen 220 and the OGI camera 224.

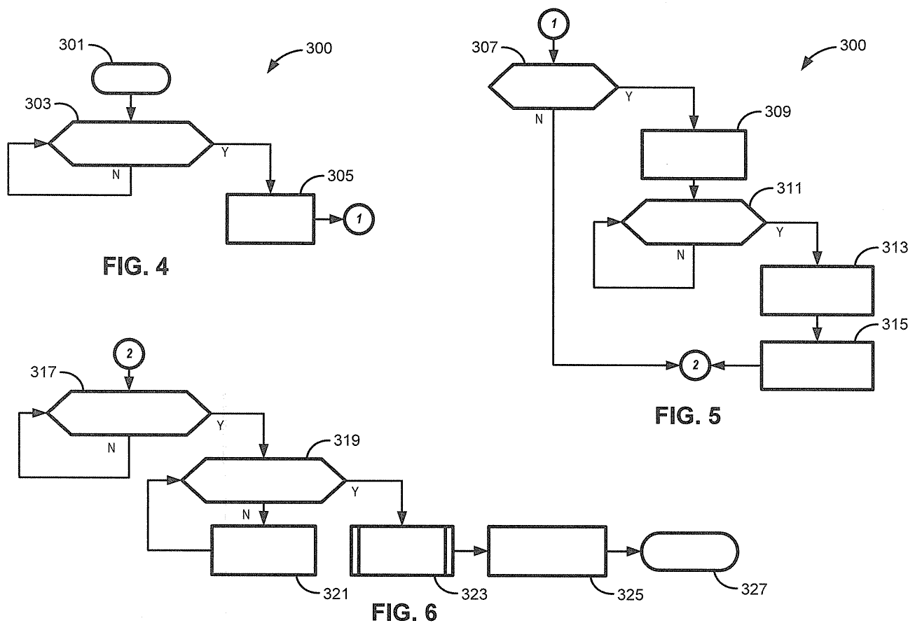

With reference next to the flow charts of FIGS. 4-8, an improved method or control protocol for governing operation of a smart testing system, such as battery cell testing system 200 of FIG. 3, for providing automated leak detection of an electrochemical device, such as prismatic batteries 110 and 200 of FIGS. 2 and 3, is generally described at 300 in accordance with aspects of the present disclosure. Some or all of the operations illustrated in FIGS. 4-8 and described in further detail below may be representative of an algorithm that corresponds to non-transitory, processor-executable instructions that are stored, for example, in main or auxiliary or remote memory (e.g., resident test system database 270 of FIG. 3 and/or remote cloud computing 24 database of FIG. 1). These instructions may be executed, for example, by an electronic controller, processing unit, dedicated control module, logic circuit, or other module or device or network of controllers/modules/devices (e.g., system controller 210 network of FIG. 3 and/or cloud computing service 24 of FIG. 1), to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 300 begins at START terminal block 301 of FIG. 4 with memory-stored, processor-executable instructions for initializing an automated, in-line gas leak detection protocol. Terminal block 301 may initialize responsive to a user command prompt (e.g., via PC computer 258 input controls), responsive to a resident system controller prompt (e.g., from PLC 236), responsive to a sensor signal indicating a new battery cell has entered the test envelope, and/or automatically in response to system power being turned on. Upon completion of some or all of the control operations presented in FIGS. 4-8, the method 300 may advance to END terminal block 327 and temporarily terminate or, optionally, may loop back to START terminal block 301 and run in a continuous loop.

Advancing from terminal block 301 to SYSTEM OPERATING TEMPERATURE decision block 303, method 300 determines whether or not the test envelope TE1 between the TC screen 220 and the OGI camera 224 has reached a predefined system/screen operating temperature. In accordance with the example presented in FIG. 3, the PLC 236 may command the servomotor-controlled guide cylinder 222 (also referred to herein as “screen mover”) to position the TC screen 220 assembly at a predefined distance from the camera 224 to define therebetween a test envelope TE1. Once properly positioned, the PLC 236 may activate and control the electrothermal device 232 to increase and/or decreased (“modify”) the operating temperature of the TC screen 220 assembly to achieve a predefined screen testing temperature (e.g., between about 100 and about 180 degrees Fahrenheit (° F.)). To monitor and control thermal variations of the TC screen 220, the PLC 236 communicates with the screen-mounted temperature sensor 234 to receive therefrom sensor signals indicative of a real-time operating temperature of the TC screen 220 assembly. The PLC 236 may command the electrothermal device 232 to actively modulate the TC screen's operating temperature based on the sensed real-time operating temperature of the TC screen 220. At the same time, the PLC 236 may communicate with the OGI camera 224 through the PC computer 258 to track a temperature gradient across the test envelope TE1. The PLC 236 may command the electrothermal device 232 to modulate the TC screen's operating temperature to thereby control the temperature gradient and ensure the gradient value is less than or equal to a maximum allowable temperature gradient (e.g., Δ_{G}≤70° F.).

If the predefined operating temperature has not yet been achieved (Block 303=NO), method 300 may run in a continuous loop until the test system/TC screen has reached the desired operating temperature. When the predefined operating temperature has been achieved (Block 303=YES), method 300 may responsively transition to TEST INITIALIZATION process block 305 and enable leak testing. At this juncture, the PLC 236 may command the cell conveyor system 212 to transport an electrochemical device 248 into the test envelope TE1 for subsequent testing. For system configurations in which the conveyor system 212 is independently operated, the PLC 236 may communicate with a proximity sensor or similarly suitable sensing device to confirm an electrochemical device 248 is positioned within the test envelope TE1.

Method 300 proceeds from process block 305 of FIG. 4 to CELL EVACUATION decision block 307 of FIG. 5 to determine if the subject device 248 being tested should be evacuated (e.g., there is not sufficient internal space for compressed CO₂ to achieve a desired can pressure). If the subject device 248 should not be evacuated (Block 307=NO), method 300 may skip process blocks 309, 311, 313 and 315 and continue directly to the gas fill protocol of FIG. 6. Upon concluding that the subject device 248 within the test envelope TE1 should be evacuated (Block 307=YES), the PLC 236 may command the linear press 204 to align and plunge the evac/fill tube 238 into contact with the fill port 244 of the device housing 246. Once properly aligned, the PLC 236 commands the linear press 204 to seal the evac/fill tube 238 to the fill port 244, e.g., by generating a predefined contact pressure between the tube 238 and port 244. After the evac/fill tube 238 is fluidly sealed to the fill port 244, method 300 executes EVAC PROTOCOL subroutine block 309 in which the PLC 236 commands the flow control valve 252 to fluidly connect the fluid pump 250 to the evac/fill tube 238 and concomitantly activates the pump 250 to draw air out of the housing 246.

After completing an evac cycle at process block 309, method 300 executes VACUUM LEVEL decision block 311 of FIG. 5 to determine if a desired vacuum level has been reached. By way of non-limiting example, the PLC 236 may communicate with the vacuum pressure sensor 240 operatively attached to the evac/fill tube 238 to ascertain whether or not a sufficient amount of gas has been evacuated from the device housing 246 through the fill port 244 to achieve a predefined internal vacuum pressure. If not (Block 311=NO), method 300 may responsively run in a continuous look through blocks 309 and 311 until the desired vacuum level is achieved. Upon confirming that the desired vacuum level has been reached (Block 311=YES), method 300 may responsively execute PUMP OFF process block 313 and deactivate the fluid pump 250. Contemporaneous with process block 313, method 300 may execute SWITCH—FILL 1 process block 315 in which the PLC 236 commands the valve 252 to both fluidly disconnect the pump 250 from the evac/fill tube 238 and fluidly connect the container 254 to the evac/fill tube 238.

Method 300 advances from process block 315 of FIG. 5 to EVACUATED CELL decision block 317 of FIG. 6 to determine if the subject device 248 being tested has been evacuated. Upon determining that the subject device 248 has not been evacuated and should be, e.g., as described in the preceding paragraph (Block 317=NO), method 300 may run in a continuous loop, e.g., returning to the cell evacuation protocol of FIG. 4, until it is determined that the subject device 248 has been evacuated. After confirming that the subject device 248 has been evacuated (Block 317=YES), method 300 may responsively execute VALVE FILL decision block 319 to determine whether or not the electronic flow control valve 252 is a fill mode in which the valve 252 fluidly connects the pressurized gas container 254 to the evac/fill tube 238 and, thus, the electrochemical device 248. If not (Block 319=NO), method 300 may responsively execute VALVE SWITCH—FILL 2 process block 321 and command the flow control valve 252 to fluidly connect the container 254 to the evac/fill tube 238. It is envisioned that process blocks 317, 319 and 321 may be deemed optional in light of the corresponding procedures presented in process blocks 307 and 315.

Method 300, after confirming that the flow control valve 252 is set to fill mode (Block 319=YES), may respond by executing LEAK DETECTION subroutine block 323 to determine whether or not a leak is present in the device housing 246 of the subject electrochemical device 248 presently within the test envelope TE1. At this juncture, the image capture module 262 resident to the PC computer 258 portion of the system controller 210 network may activate and control operation of the OGI camera 224 to capture one or more infrared images of the subject device 248. It may be desirable that each captured infrared image show the fill port 244 and/or device housing 246 located in front of the heated TC screen 220 assembly. Prior to analysis, the infrared images may be filtered, preprocessed, smoothed, compressed, and stored in the server system database 270.

After capturing and, if desired, saving Middle Wavelength Infrared (MWIR) images the subject device 248, the image analysis module 266 resident to the PC computer 258 analyzes the captured infrared image(s) to ascertain whether or not a gas leak is present in the device housing 246. In a non-limiting example, image analysis module 266 examines each captured infrared image to evaluate imaged MWIR waves that are generated by the electrothermal device 232 and pass between the TC screen 220 and the device housing 246, e.g., along an upper rear edge of the housing 246. The image analysis module 266 uses a gas cloud modeling algorithm to then locate one or more aberrations, if any, within these imaged MWIR waves; it may be determined that each aberration is caused by compressed CO₂ gas leaking from the device housing 246 (e.g., from a cracked O-ring seal of the fill port 244). For at least some applications, an optional mirror assembly 274 (FIG. 3) may be positioned between the device housing's fill port 244 and one of the adjoining flaps 230 of the TC screen 220 assembly. It may be desirable that the mirror assembly 274 be securely mounted to and, thus, moves in unison with the TC screen 220 assembly. The mirror assembly 274 may help to redirect MWIR waves to help improve analysis of the subject electrochemical device 248 for leak detection. Upon completion of the leak detection analysis at block 323, method 300 may execute VALVE SWITCH—EVAC1 process block 325 in which the PLC 236 commands the flow control valve 252 to switch back to an evacuation mode; method 300 then loops back to process block 307 of FIG. 5 to evaluate another electrochemical device. Alternatively, method the PLC 236 may command the flow control valve 252 to switch to a closed mode; method 300 may then advance to END terminal block 327 and temporarily terminate.

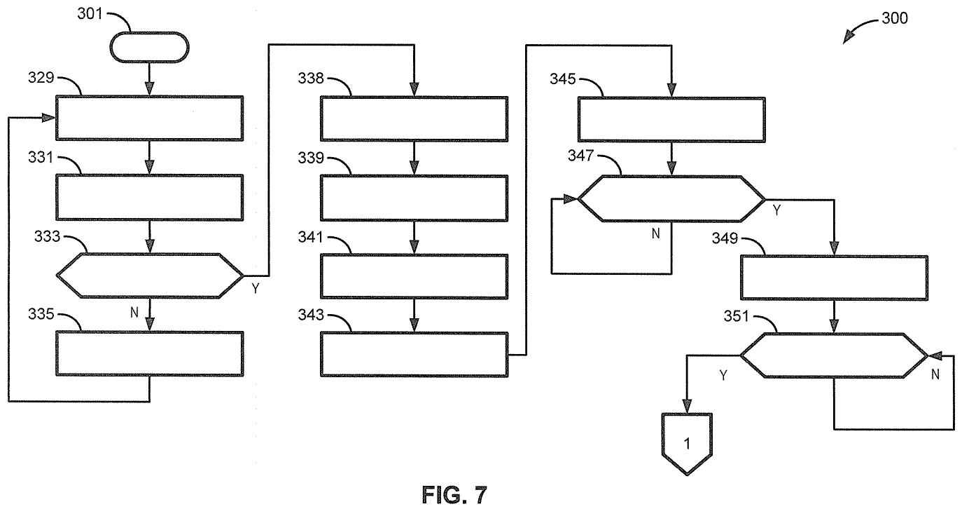

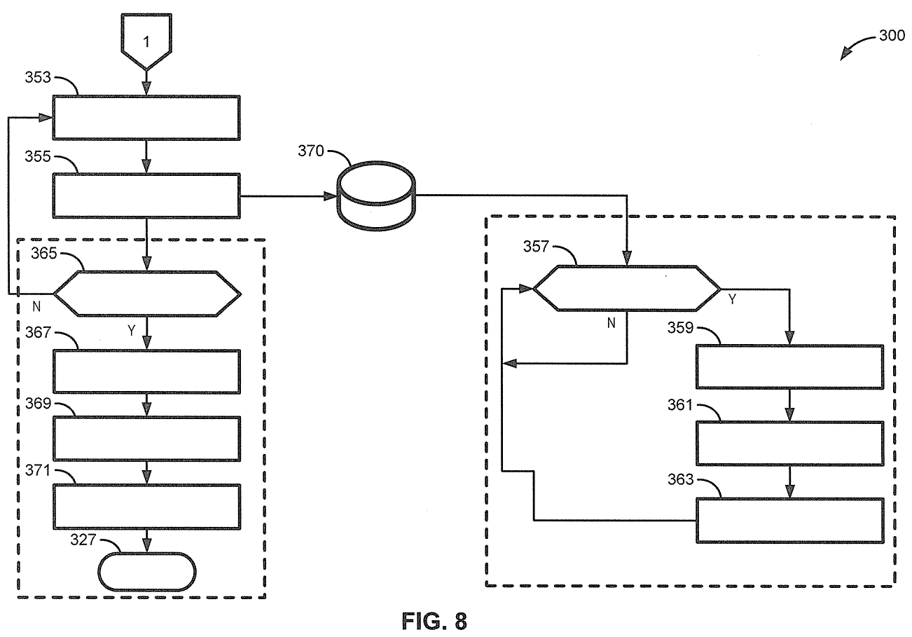

In tandem with the various control processes presented in FIGS. 4-6 and described above, the system controller 210 network of FIG. 3, including PLC 236, PC computer 258, and digital temperature controller 260, may collaboratively execute the control processes presented in FIGS. 7 and 8. For instance, PLC 236 may initialize the gas leak detection protocol associated with START terminal block 301 upon detection of one or more prismatic battery cells 248 arriving at the battery cell testing system 200 station, as indicated at CELL PALLET DETECTION process block 329 of FIG. 7. Upon detection of a new pallet of battery cells, method 300 may responsively execute PALLET SCAN process block 331; at this juncture, the PLC may read an RFID tag, NFC transponder, QR code, or other similarly suitable data device to retrieve information related to the prismatic battery cells present on the new pallet. From the retrieved data, the PLC 236 may determine if the cell or cells on the pallet is/are not designated as a “reject” at CELL REJECT decision block 333. If the pallet cell(s) are designated as rejects (Block 333=NO), PLC 236 may responsively execute DROP PALLET-1 process block 335 to stop and release the new pallet; at this juncture, method 300 may loop back to process block 329 and await arrival of a new pallet.

Upon concluding that the pallet cell(s) are not designated as rejects (Block 333=YES), PLC 236 may responsively execute PALLET POSITIONING process block 337 to lift and locate the pallet, e.g., for sequential feeding of the individual battery cells into the test fixture 202 via the conveyor subsystem 212. At FILL TUBE process block 339, the PLC 236 may command the linear press 204 to lower the evac/fill tube 238 into contact with the fill nozzle 244 of each cell 248 under evaluation for gas leaks. The PLC 236 may thereafter execute NOZZLE SEAL process block 341 and command the linear press 204 to add a predefined pressure (e.g., 5 lbs) to the fill nozzle 244 via the evac/fill tube 238 to create a fluid seal therebetween. Once the evac/fill tube 238 is sealed to the fill nozzle 244, the PLC 236 executes VALVE SWITCH—EVAC2 process block 343 and commands the valve 252 to switch to evacuation mode.

After fluidly connecting the fluid pump 250 to the battery cell fill nozzle 244 via the valve 252 and evac/fill tube 238, the PLC 236 may execute EVAC PROTOCOL process block 345 and turn on the fluid pump 250. At VACUUM ACHIEVED decision block 347, the PLC 236 may determine if the evacuated cell housing 246 has reached a desired vacuum level. If so (Block 347=YES), the PLC 236 may execute VALVE SWITCH—FILL 3 process block 349 and command the flow control valve 252 to switch to fill mode and thereby fluidly connect the container 254 to the evac/fill tube 238. PLC 236 may thereafter execute FILL ACHIEVED decision block 351 to determine whether or not the evacuated and filled cell housing 246 has reached a desired internal gas pressure level. If so (Block 351=YES), the method 300 may automatically advance to IMAGE ACQUISITION process block 353 of FIG. 8.

With reference next to FIG. 8, PC computer 258 may execute IMAGE ACQUISITION process block 353 and capture infrared images of each cell 248 under evaluation for gas leaks using the OGI camera 224. Each captured image may be stored in the server system database 270 or other solid-state drive (SSD) memory at WRITE TO DISC process block 355. After writing each image to disc, PC computer 258 may execute SAVED IMAGE decision block 357 to determine if each image has been properly saved. If so (Block 357=YES), the PC computer 258 may responsively execute—in sequence—LOAD IMAGE process block 359, PROCESS IMAGE process block 361 and WRITE IMAGE process block 363 to respectively load, process, and save each processed image. Process blocks 357, 359, 361 and 363 may be executed for each captured infrared image.

Method 300 may advance from WRITE TO DISC process block 355 to TIME LAPSE process block 365 of FIG. 8, whereat the PC computer 258 may determine if a preset image capture window (e.g., approximately five (5) seconds) has elapsed. If not (Block 365=NO), method 300 may loop back to process block 353 and capture additional infrared images of the subject cell 248. Upon determining that the preset image capture window has elapsed (Block 365=YES), the PC computer 258 may respond by executing STOP ACQUISITION process block 367 and command the OGI camera 224 to temporarily stop acquiring images. Depending on the results of the leak detection analysis for each evaluated battery cell 248, the PC computer 258 may write PASS or FAIL to the pallet RFID tag/data device at ANALYSIS RESULTS process block 369. The PC computer 258 may thereafter execute DROP PALLET-2 process block 371 to release the evaluated pallet; at this juncture, method 300 may loop back to process block 329 and await arrival of a new pallet or may transition to END terminal block 327.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of detecting a leak in an electrochemical device, the electrochemical device including a device housing with a fill port, the method comprising:
positioning a temperature-controlled (TC) screen with an electrothermal device at a predefined distance from an infrared camera to define therebetween a test envelope;
commanding, via a system controller, the electrothermal device to modify a screen operating temperature of the TC screen to a predefined screen testing temperature;
positioning the electrochemical device in the test envelope between the TC screen and the infrared camera;
capturing, using the infrared camera, an infrared image of the electrochemical device within the test envelope showing the device housing located in front of the TC screen; and
analyzing, via the system controller, the captured infrared image of the electrochemical device to determine if a gas leak is present in the device housing.

2. The method of claim 1, further comprising:
receiving, via the system controller from a temperature sensor attached to the TC screen, sensor signals indicative of a real-time operating temperature of the TC screen; and
commanding, via the system controller, the electrothermal device to modulate the screen operating temperature based on the real-time operating temperature of the TC screen.

3. The method of claim 2, wherein the temperature sensor is mounted to a bottom edge of a front camera-facing surface of the TC screen.

4. The method of claim 1, further comprising:
monitoring, via the system controller using the infrared camera, a temperature gradient across the test envelope; and
commanding, via the system controller, the electrothermal device to modulate the screen operating temperature to thereby maintain the temperature gradient at a gradient value less than or equal to a maximum allowable temperature gradient.

5. The method of claim 1, further comprising:
commanding, via the system controller after the electrochemical device is positioned in the test envelope, a linear press to move an evac/fill tube into contact with the fill port of the device housing; and commanding, via the system controller, the linear press to seal the evac/fill tube to the fill port, wherein the evac/fill tube is fluidly coupled to a fluid pump.

6. The method of claim 5, further comprising commanding, via the system controller after the evac/fill tube is sealed to the fill port, the fluid pump to evacuate gas from the device housing through the fill port to produce a predefined vacuum pressure within the device housing.

7. The method of claim 6, further comprising commanding, via the system controller after the fluid pump evacuates the gas from the device housing, a flow control valve to open and thereby transmit pressurized gas into the device housing through the evac/fill tube and the fill port.

8. The method of claim 7, wherein the flow control valve includes a three-way multiport pressure center valve fluidly coupling the fluid pump and a pressurized gas container to the evac/fill tube.

9. The method of claim 1, further comprising positioning a mirror assembly between the fill port of the device housing and a select portion of the TC screen.

10. The method of claim 1, wherein analyzing the captured infrared image includes:
evaluating imaged Middle Wavelength Infrared (MWIR) waves generated by the electrothermal device and passing between the TC screen and the device housing; and
locating an aberration in the imaged MWIR waves caused by compressed gas leaking from the electrochemical device.

11. The method of claim 9, wherein the TC screen includes a U-shaped plate assembly with a metallic center plate and a pair of metallic flaps each projecting from a respective opposing edge of the metallic center plate.

12. The method of claim 11, wherein the electrothermal device includes a silicone rubber heating pad attached to the metallic center plate and the pair of metallic flaps such that MWIR waves generated by the electrothermal device pass from the silicone rubber heating pad, through the metallic flaps, and across the device housing.

13. The method of claim 1, further comprising positioning an air-control canopy around the TC screen and the electrochemical device.

14. A non-transient, computer-readable medium storing instructions executable by one or more processors of a system controller of a leak testing system for detecting a leak in an electrochemical device, the electrochemical device including a device housing with a fill port, the instructions, when executed by the one or more processors, causing the system controller to perform operations comprising:
commanding a screen mover to position a temperature-controlled (TC) screen with an electrothermal device at a predefined distance from an infrared camera to define therebetween a test envelope;
commanding the electrothermal device to increase a screen operating temperature of the TC screen to a predefined screen testing temperature;
confirming the electrochemical device is positioned in the test envelope between the TC screen and the infrared camera;
capturing, using the infrared camera, an infrared image of the electrochemical device within the test envelope showing the device housing located in front of the TC screen; and
analyzing the captured infrared image of the electrochemical device to determine if a gas leak is present in the device housing.

15. A leak testing system, comprising:
a test fixture configured to receive an electrochemical device including a device housing with a fill port;
an infrared camera mounted to the test fixture;
a temperature-controlled (TC) screen, with an electrothermal device attached to a thermally conductive plate, movably mounted to the test fixture proximate the infrared camera via a screen mover; and
a system controller communicatively connected to the electrothermal device, the screen mover, and the infrared camera, the system controller being programmed to:
command the screen mover to position the TC screen at a predefined distance from the infrared camera to define therebetween a test envelope;
command the electrothermal device to increase a screen operating temperature of the TC screen to a predefined screen testing temperature;
confirm the electrochemical device is positioned in the test envelope between the TC screen and the infrared camera;
command the infrared camera to capture an infrared image of the electrochemical device within the test envelope showing the device housing and the fill port located in front of the TC screen; and
analyze the infrared image of the electrochemical device to determine if a gas leak is present in the device housing.

16. The leak testing system of claim 15, further comprising from a temperature sensor attached to the TC screen, wherein the system controller is further programmed to:
receive, from the temperature sensor, sensor signals indicative of a real-time operating temperature of the TC screen; and
command the electrothermal device to modulate the screen operating temperature based on the real-time operating temperature of the TC screen.

17. The leak testing system of claim 15, wherein the system controller is further programmed to:
monitor, using the infrared camera, a temperature gradient across the test envelope between; and
command the electrothermal device to modulate the screen operating temperature to thereby maintain the temperature gradient at a value less than or equal to a maximum allowable temperature gradient.

18. The leak testing system of claim 15, further comprising a linear press, an evac/fill tube mounted to the linear press, and a fluid pump fluidly coupled to the evac/fill tube, wherein the system controller is further programmed to:
after the electrochemical device is positioned in the test envelope, command the linear press to move the evac/fill tube into contact with the fill port of the device housing; and
command the linear press to seal the evac/fill tube to the fill port.

19. The leak testing system of claim 18, wherein the system controller is further programmed to command, after the evac/fill tube is sealed to the fill port, the fluid pump to evacuate gas from the device housing through the fill port to produce a predefined vacuum pressure within the device housing.

20. The leak testing system of claim 19, wherein the system controller is further programmed to command, after the fluid pump evacuates the gas from the device housing, a flow control valve to open and thereby transmit pressurized gas into the device housing through the evac/fill tube and the fill port.
